(19) United States
(12) Patent Application Publication
(10) Pub. No.: US 2014/0034087 A1
(43) Pub. Date: Feb. 6, 2014

(54) PORTABLE AUTOMATED MINI-BULK CONTAINER RINSING SYSTEM AND METHOD PROVIDING CLOSED SYSTEM MINI-BULK CONTAINER RINSING FOR MINI-BULK CONTAINER REUSE OF DISPOSAL

(71) Applicants: Jeffrey R. Susalla, Apex, NC (US); Douglas J Mattson, Liberty, MO (US)

(72) Inventors: Jeffrey R. Susalla, Apex, NC (US); Douglas J Mattson, Liberty, MO (US)

(73) Assignee: Bayer Cropscience LP, Reasearch Triangle Park, NC (US)

(21) Appl. No.: 14/004,295

(22) PCT Filed: Mar. 26, 2012
(86) PCT No.: PCT/US12/30529

§ 371 Date: Oct. 2, 2013

Related U.S. Application Data
(60) Provisional application No. 61/467,670, filed on Mar. 25, 2011.

(51) Int. Cl. B08B 9/093

(52) U.S. Cl. CPC B08B 9/093; B08B 9/0936
USPC 134/24; 134/166 R; 134/167 R; 134/22.1

(57) ABSTRACT

A portable automated mini-bulk container rinsing system for rinsing mini-bulk containers in a closed, efficient environmentally friendly and economical manner is disclosed. The system includes a cap attachable to a mini-bulk container opening; a rigid tube extending from the cap configured to extend into the mini-bulk container interior; a spray head coupled to the tube at a distal end of the tube spaced from the cap and configured to be within the mini-bulk container interior when the cap is attached to the mini-bulk container opening; and a fluid coupling member attached to an end of the rigid tube opposite the spray head and adapted to be coupled to a source of cleaning fluid, wherein fluid under pressure can flow from the source, through the fluid coupling, through the tube and through the spray head to rinse the mini-bulk container when the cap is coupled to the mini-bulk container opening.

The present invention claims priority of U.S. Provisional Patent Application Ser. No. 61/467,670 entitled “Portable Automated Mini-Bulk Container Rinsing System and Method Providing Closed System Mini-Bulk Container Rinsing for Mini-Bulk Container Reuse and Disposal” filed Mar. 25, 2011.

### BACKGROUND OF THE INVENTION

1. Field of the Invention

The present invention relates to a portable automated tank rinsing system and associated method for rinsing tanks, such as mini-bulk containers used for pesticides and fertilizers, in a safe, environmentally friendly and economical manner.

2. Background Information

The Federal Insecticide, Fungicide, and Rodenticide Act (FIFRA), is one of two major federal pesticide statutes which the U.S. Environmental Protection Agency (EPA) is responsible for implementing. FIFRA governs the sale, transport, storage and use of pesticide products within the United States. FIFRA directs EPA to restrict the use of pesticides as necessary to prevent unreasonable adverse effects on people and the environment taking into account the costs and benefits of various pesticide uses. The other major federal statute regulating pesticides is the Federal Food, Drug, and Cosmetic Act (FFDCA), which limits pesticide residues on food in interstate commerce (including imports). Within the United States, about half of the states have their own regulations regarding pesticides and/or fertilizers and their associated containers that supplement the federal guidelines.

Pesticides are broadly defined in FIFRA as chemicals and other products used to kill, repel, or control pests. Familiar examples include pesticides used to kill insects and weeds that can kill, reduce the yield, and sometimes harm the quality of agricultural crops, ornamental plants, forests, wooden structures, and also pastures. But the broad definition of “pesticide” in FIFRA also applies to products with less familiar “pesticide uses.” Substances used to control mold, mildew, algae, and other nuisance growths on equipment, in surface water, or on stored grains are pesticides. The term also applies to disinfectants and sterilizing agents, animal repellents, rat poison, and many other substances. The EPA estimates that as of May 2003, there were over 19,000 pesticide products currently in use. These all are regulated under FIFRA, but approximately 6,500 pesticide products used in food production also are regulated under the FFDCA.

Fertilizers are any of a large number of natural and synthetic materials, including manure and nitrogen, phosphorus, and potassium compounds, spread on or worked into soil to increase its capacity to support plant growth. Fertilizers will be generally classified as pesticides if they are combined with pesticide components (e.g., an herbicide/fertilizer mixture). Even those fertilizers that are not classified under the broad definition of pesticides are subject to a number of fertilizer related state and federal regulation regarding labeling, use, transport, storage and the like.

Pesticides and fertilizers are often sold in bulk containers and a significant percentage of these are sold in what is generally regarded as a subset of bulk containers known as mini-bulk containers (AKA mini-bulk shuttles or simply mini-bulks). Bulk containers within the meaning of pesticides have typically been described as individual containers above a certain amount for liquid pesticides and a certain amount for dry pesticides. Precise definitions of bulk containers are not quite uniform as above 40 gallons has been used as a lower limit for “bulk containers” (e.g., in Ohio) whereas other jurisdictions use a lower cutoff in the definition of bulk container of 55 or 56 U.S. gallons for liquid pesticides, and still others may have a slightly differing lower liquid cutoff amount. Dry pesticides of 100 LBS or more seems to be a somewhat common lower limit for the definition of “bulk containers”.

The mini-bulk container subset of bulk pesticide containers also suffers from similar imprecision as it has been defined, for liquid pesticides, as containers of 40 to 600 gallons (Ohio), and 56 to about 500 gallons (Minnesota) and 55 gallon to 350 gallons (Wisconsin); and for dry pesticides the mini-bulk container has been defined as containers holding about 100 lbs to about 400 lbs, 100 lbs to about 500 lbs, 100 lbs to about 600 lbs, 100 lbs to about 1000 lbs, and even 100 lbs to 2,500 lbs of dry pesticide. A precise definition of mini-bulk containers is not critical in the art, however within the meaning of this application the term will reference a container accommodating about 40 to 600 gallons of liquid material such as pesticide and/or fertilizer, or about 100 to 2,500 lbs of dry material such as pesticide and/or fertilizer.

Generally speaking, if the chemicals of a pesticide and/or fertilizer are compatible with the mini bulk container and normal care is taken, then a mini bulk container used with agricultural chemicals should last 5-7 years. An estimated 500,000 mini bulk containers are in service today, with an estimated 50,000 to be obsolete (currently effective Aug. 16, 2011) under new EPA rules. Additionally an estimated 100,000 mini-bulk containers are out of service (often behind barns and warehouses). It is expected the industry may soon spend large sums recycling and replacing obsolete mini bulk containers in addition to the costs associated with the use, storage and transport of in service mini bulk containers.

The EPA promulgated a rule in 2006 (with some intervening clarifications and updates) that was to regulate the use and distribution of refillable pesticide mini bulk containers. When it amended the FIFRA, the EPA was required by Congress to promulgate regulations prescribing procedures and standards for container design and standards and the removal of pesticides from containers prior to disposal. The purpose of the rule is straightforward and clear, namely to: i) Minimize human exposure during container handling and use; ii) Provide for a reasonable indication if anyone other than the authorized filler or refiller has introduced material into a refillable container; iii) Facilitate container disposal and recycling; and iv) Encourage the use of refillable containers. As a result all mini bulk containers, new or currently in use as refillable containers must be compliant with the defined regulations for such containers as of Aug. 16, 2011, without exception. There was no grace period nor “grandfathering” provisions in the rule.

In brief overview, as of Aug. 16, 2011, all portable refillable containers must meet the following requirements: (i) One-way valves or tamper evident device on openings (other than vents) is required. (ii) Containers must have a unique method of identification such as a serial number or other ID code. (iii) Containers must meet DOT design, construction, marking. (iv) Containers must be cleaned between uses unless tamper evident and/or one-way valves are intact and filled with same product, and rinsing is required before container disposal; (v) Containers must be on an approved list from the registrant; (vi) User's must have registrant's cleaning instructions and repackaging authorization on hand; (vii)EPA Est. # and net contents must be on the product label affixed to the container; (viii) Container integrity is the responsibility of both refiller and the registrant; and (ix) Records must be kept for each inspection and fill or refill.

Regarding recycling or disposing of used containers, only clean, empty containers are accepted by non-hazardous waste landfills or container collection centers. Proper rinsing of empty pesticide containers prior to recycling or disposal is a requirement of FIFRA and properly rinsed pesticide containers are considered non-hazardous solid waste by the Federal Resource Conservation and Recovery Act (RCRA).

In addition to the regulatory requirement, rinsing of pesticide and/or fertilizer containers saves money for the user, and helps protect people and the environment. Rinsate from the container, when added directly into a user's sprayer tank, efficiently and economically uses all pesticide and/or fertilizer in the container. This eliminates the need to store and later dispose of the rinsate. Rinsing containers removes a potential source of pesticide exposure to soil, surface, and ground water and thus removes a potential source of pesticide exposure to people, animals, and wildlife. Thus proper rinsing is required by federal and state regulations and is a good, sound agricultural and environmental practice.

Proper rinsing of containers has been shown to be highly effective at product removal. Immediate and proper rinsing removes more than 99% of the container residues typically left by most pesticide formulations. Properly rinsed pesticide containers pose minimal risk for contamination of soil and water resources. Preventing contamination is an important part of pesticide management. Regarding proof of effectiveness of rinsing containers, pesticide residues measured in selected containers that passed visual inspection in the Minnesota Container Collection and Recycling project show rinsing at the time of use is highly effective:

Percent of pesticide residue removed with proper rinsing

| Pesticide | Container | % Removal |
|---|---|---|
| 2,4-D | 2.5 gallon plastic | 99.9999 |
| pendimethalin | 2.5 gallon plastic | 99.9969 |
| alachlor | 5.0 gallon metal | 99.9998 |
| glyphosate | 1.0 gallon plastic | 99.9989 |
| metolachlor | 2.5 gallon plastic | 99.9999 |
| carbofuran | 2.5 gallon plastic | 99.9993 |

Pressure rinsing is effective for proper rinsing of pesticide containers such as mini-bulk containers. In pressure rinsing, a special nozzle is attached to the end of a hose to force the remaining pesticide and/or fertilizer from the container. Pressure-rinsing, which may be faster and easier than triple-rinsing, can be used with plastic and non-pressurized metal pesticide containers. The standard for pressure rinsing a container, after the container has been emptied, includes inserting a pressure-nozzle into the container (note that for non-reusable small containers such as 2.5 gallon container this may be by puncturing through the lower side of the pesticide container). The pressure nozzles typically operate at 15-100 psi with 40-80 psi being more common, and appropriate water sources are available in most conventional agricultural and residential settings. The conventional current rinsing instructions require the user to “wiggle nozzle to rinse all inside surfaces” and to rinse all surfaces for a certain time such as 30 seconds.

Pesticide containers should be rinsed as soon as they are empty; thus, the time to rinse is during the mixing and loading process. Immediate rinsing has several advantages. A freshly emptied container is easier to clean because the formulation residues have not had time to dry and cake on the inside of the container, in other words unless rinsed from the container immediately, some pesticides can solidify and become difficult to remove. Also, rinsing containers during the mixing and loading process solves the problem of what to do with container rinse water as it is used to contribute to the water used to prepare the finished spray mix.

Substantial effort has been made in evaluating the benefits of rinsing fertilizer and pesticide containers and in promulgating rules demanding some type of rinsing procedure be performed. However there has been very little effort in developing simple, inexpensive, easy to use tools to facilitate effective and safe container rinsing. As discussed above currently rinsing is a manual procedure. This manual procedure unduly exposes the operator performing the rinsing and the immediate environment to the open container being rinsed as well as to rinsate splash back during the procedure. The open top through which the user accesses the container to perform rinsing serves as a point of possible contamination to the operator and to the environment, as well as a potential needless loss of valuable product in the rinsate.

It is an object of the present invention to address the deficiencies of the prior art discussed above and to provide an easily operable, simple tool yielding a portable automated tank rinsing system and associated method for rinsing mini-bulk containers, such as used for pesticides and fertilizers, in a closed, efficient, environmentally friendly and economical manner.

### SUMMARY OF THE INVENTION

The various embodiments and examples of the present invention as presented herein are understood to be illustrative of the present invention and not restrictive thereof and are non-limiting with respect to the scope of the invention. According to one non-limiting embodiment of the present invention, a portable automated mini-bulk container rinsing system for rinsing mini-bulk containers in a closed, environmentally friendly and economical manner is disclosed with the system including a cap attachable to an opening in a mini-bulk container; a rigid tube extending from the cap configured to extend into the interior of the mini-bulk container; a spray head coupled to the tube at a distal end of the tube spaced from the cap configured to be in a position within the interior of the mini-bulk container when the cap is attached to the opening of the mini-bulk container; and a fluid coupling member attached to an end of the rigid tube opposite the spray head and adapted to be coupled to a source of cleaning fluid, wherein fluid under pressure can flow from the source, through the fluid coupling, the tube and through the spray head to rinse the mini-bulk container when the cap is coupled to the mini-bulk container opening.

In the portable automated mini-bulk container rinsing system according to one aspect of the invention the spray head may be a rotary spray head that is configured to rotate when dispensing fluid under pressure. Further the rotary spray head may have a spray angle as measured in a plane generally parallel to a longitudinal axis of the tube that will extend from an end spray line intersecting the cap about an arc associated with the interior of the mini-bulk container when the cap is attached to the opening of the mini-bulk container to a second end spray line intersecting the cap.

In the portable automated mini-bulk container rinsing system according to one aspect of the invention the cap may be configured to substantially seal the mini-bulk container opening when attached to the container opening. The cap may include an annular seal configured to engage the mini-bulk container around the mini-bulk container opening when the cap is attached to the mini-bulk container opening. The cap may include threads for attaching to the mini-bulk container opening, and the fluid coupling includes threads for attaching to the source of cleaning fluid.

According to one non-limiting embodiment of the present invention, a method for rinsing a mini-bulk container comprising the steps of: Providing a portable mini-bulk container rinsing system having a cap, a rigid tube extending from the cap with a spray head coupled to the tube at one distal end of the tube spaced from the cap, and a fluid coupling member attached to an opposed distal end of the rigid tube opposite the spray head; Attaching the cap of the mini-bulk container rinsing system to an opening in the mini-bulk container, wherein tube and the spray head extend into the interior of the mini-bulk container; Attaching the fluid coupling member to a source of cleaning fluid; and Supplying, for a period of time, cleaning fluid under pressure from the source of cleaning fluid to the rinsing system, whereby fluid under pressure can flow from the source, through the fluid coupling, the tube and through the spray head to rinse the mini-bulk container.

In one embodiment of the invention the cleaning fluid is water while an alternative embodiment further includes the step of reusing rinsate for rinsing of the mini-bulk container.

The method for rinsing a mini-bulk container according to the invention may further include the step of rotating the spray head more than 360 degrees when dispensing fluid under pressure during rinsing of the mini-bulk container.

According to one non-limiting embodiment of the present invention, a method for preparing a mini-bulk container for reuse or disposal comprises the steps of: Providing a portable mini-bulk container rinsing system having a threaded cap, a rigid tube extending from the cap with a rotary spray head coupled to the tube at one distal end of the tube spaced from the cap, and a threaded fluid coupling member attached to an opposed distal end of the rigid tube opposite the rotary spray head; Sealing the mini-bulk container to provide a substantially closed system by attaching the threaded cap of the mini-bulk container rinsing system to an opening in the mini-bulk container, wherein tube and the rotary spray head extend into the interior of the mini-bulk container; Attaching the fluid coupling member to a source of cleaning fluid; and Rinsing the interior to the mini-bulk container by supplying, for a period of time, cleaning fluid under pressure from the source of cleaning fluid to the rinsing system, whereby fluid under pressure can flow from the source, through the fluid coupling, the tube and through the rotary spray head to rinse the mini-bulk container.

These and other advantages of the present invention will be clarified in the description of the preferred embodiments taken together with the attached figures.

### BRIEF DESCRIPTION OF THE DRAWING

FIG. 1 is a schematic side view of a portable automated mini-bulk container rinsing system for rinsing mini-bulk containers in a closed, environmentally friendly and economical manner in accordance with one embodiment the present invention;

FIG. 2 is schematic side view of the portable automated mini-bulk container rinsing system of FIG. 1 associated with a mini-bulk container;

FIG. 3 is schematic enlarged side view of a cap portion of the portable automated mini-bulk container rinsing system of FIG. 1 coupled with a mini-bulk container;

FIG. 4 is schematic side view of the portable automated mini-bulk container rinsing system of FIG. 1 associated with a mini-bulk container as in FIG. 2 and further incorporating a rinsate recycling component; and

FIG. 5 is schematic enlarged side view of a cap portion of an alternative portable automated mini-bulk container rinsing system of the present invention coupled with a mini-bulk container.

### DESCRIPTION OF THE PREFERRED EMBODIMENTS

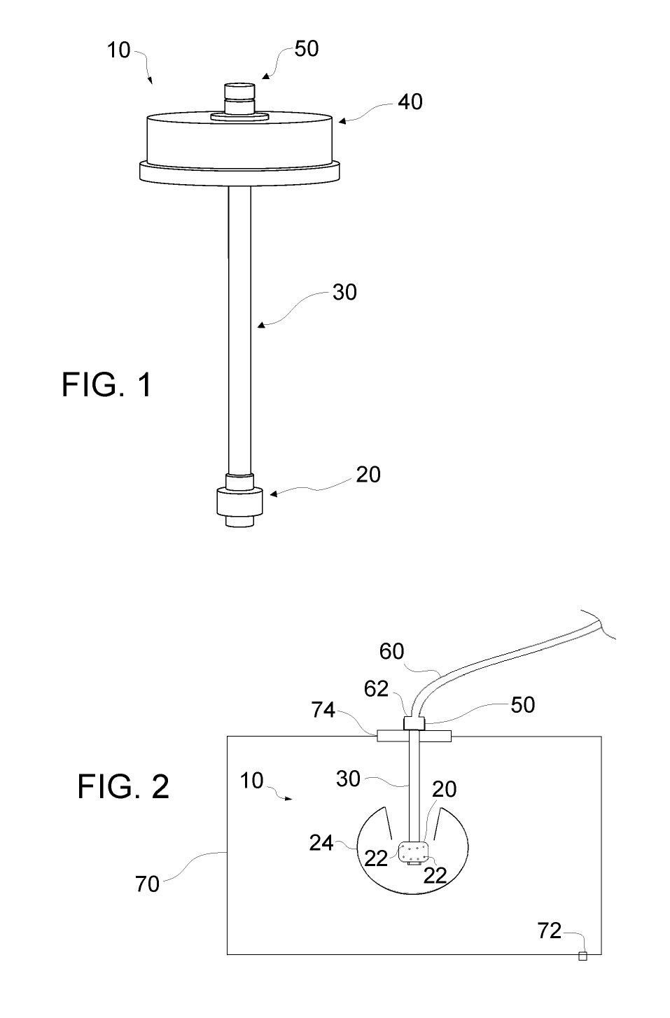

In summary, the present invention relates to a portable automated mini-bulk container rinsing system 10 schematically shown in FIG. 1 for rinsing mini-bulk containers 70 in a closed, efficient, environmentally friendly and economical manner as schematically shown in FIGS. 2 and 4.

The portable automated mini-bulk container rinsing system 10 for rinsing mini-bulk containers 70 includes, in overview, a cap 40 attachable to an opening 74 in the mini-bulk container 70; a rigid tube 30 extending from the cap 40 and configured to extend into the interior of the mini-bulk container 70; a spray head 20 coupled to the tube 30 at a distal end of the tube 30 spaced from the cap 40 and configured to be in a position within the interior of the mini-bulk container 70 when the cap 40 is attached to the opening 74 of the mini-bulk container 70; and a fluid coupling member 50 attached to an end of the rigid tube 30 opposite the spray head 20 and adapted to be coupled to a source of cleaning fluid, wherein fluid under pressure can flow from the fluid source, through the fluid coupling 50, through the tube 30 and through the spray head 20 to rinse the mini-bulk container 70 when the cap 40 is coupled to the mini-bulk container opening 74 and the control or valve for the fluid source is opened.

The spray head 20 of the present invention is significant in operation and it needs to reach the entire, or substantially the entire, interior of the mini-bulk container 70. The spray head 20 is preferably a rotary spray head with a plurality of nozzles 22 and which head 20 rotates more than 360 degrees in response to pressurized fluid, generally water, with the spray heads operating at 20-100 PSI with 40-80 PSI operation being more common operating pressures, being dispensed there through the nozzles 22. Rotary spray heads are known to utilize less fluid than a stationary spray ball covering the same area. Due to the rotation of the spray head 20 the area of coverage of the spray head 20 in measured in the plane perpendicular to the tube 30 is a full 360 degrees. The rotary spray head 20 has a spray angle 24 as measured in a plane generally parallel to a longitudinal axis of the tube 30 that will extend from an end spray line 24 intersecting the cap 40 about an arc associated with the interior of the mini-bulk container 70 when the cap 40 is attached to the opening 74 of the mini-bulk container 70 to a second end spray line 24 intersecting the cap 40 as generally shown in FIGS. 2-4. This spray head 20 arrangement allows the spray head 20 to cover the entire interior of the container 70 during rinsing. The present invention could utilize a spray head 20 formed of a stationary spray ball or reciprocating spray unit provided that the entire interior, or substantially the entire interior, of the container 70 is adequately covered with the spray when the system 10 is attached to the container 70 for sufficient rinsing.

A wide variety of spray heads may be utilized to form the head 20. Suitable examples of similar spray heads include the TEEJET brand rotating spray head, the RSH brand rotary spray head, Bete Ltd brand rotary spray heads, Sealpump Engineering Limited wash nozzles, Scanjet Systems rotary spray heads and Bon Aire rotating spray heads. There are a number of companies that manufacture suitable rotary spray heads for construction of the present system 10. It is important however that the spray head 20 be selected with suitable coverage to cover the entire interior, or substantially the entire interior, of the container 70 and this can be effected by the length of the tube 30 from the cap 40. Further the spray head 20 must be selected such that will operate in conventional water pressures found in typical agricultural environments. Rotating spray heads are made for any operating pressures with commonly commercially available spray heads designated for operation from 10 PSI to 100 PSI, wherein 40-80 PSI represents more conventional water pressures that are experienced typically making this a more convenient operational range.

The tube 30 is a hollow tube with sufficient rigidity to hold the spray head 20 in the designated position in operation. Plastic plumbing piping (typically 1/2″ to 4″ diameter) is suitable and is easily attached to the rotary spray head 20. The tube 70 is most easily formed as a straight member and is designed to extend about half way in to a number of mini-bulk containers 70.

Many mini-bulk containers have a central opening 74 to facilitate even filling of the interior of the mini-bulk container 70, further even slightly off center positioning of the spay head 20 will allow for proper rinsing provided the entire interior of the container 70 can be adequately reached with the spray head spray pattern (generally 24). However, as an alternative design, a curved rigid member could be used to form the tube 30 such as for mini-bulk containers in which the opening 74 is offset from the center of the container, thus a curved tube 30 could be used in that case to better center the location of the spray head 20.

A semi-flexible tube, i.e. one that can be moved (manually flexed) to a designated position and be rigid enough to hold that position in use (such as metal flexible corrugated tubing) could be used, to form tube 30 to allow the user to adjust the position of the head 20 between uses to better accommodate alternative mini-bulk container shapes (that the cap 40 is appropriate for). In evaluating this alternative embodiment the additional cost of the flexible tubing that can hold a desired flexed shape which would form tube 30 in this embodiment would need to be considered, but it may have certain perceived benefits to the users. It is important that the system 10 of the invention be relatively cost effective and simple and easy to implement, as well as being efficient for the rinsing operation. Violating any of these design criteria excessively could significantly restrict user adoption of the system 10 and thus minimize the advantages of using such a system 10 for the user and the environment.

In a further embodiment a flexible tube (i.e. one that would not hold a flexed position) could be used to form the tube 30, provided it does not result in detrimental oscillation of the spray head 20 in operation to an extent that the spray head 20 contacts the side of the container 70 in use. The flexible tube embodiment may offer some advantage to the types of material used to form the tube 30 and may offer some advantages to shipping and storage, however a straight rigid plastic component discussed above is believed to be the most cost effective and efficient for forming the tube 30.

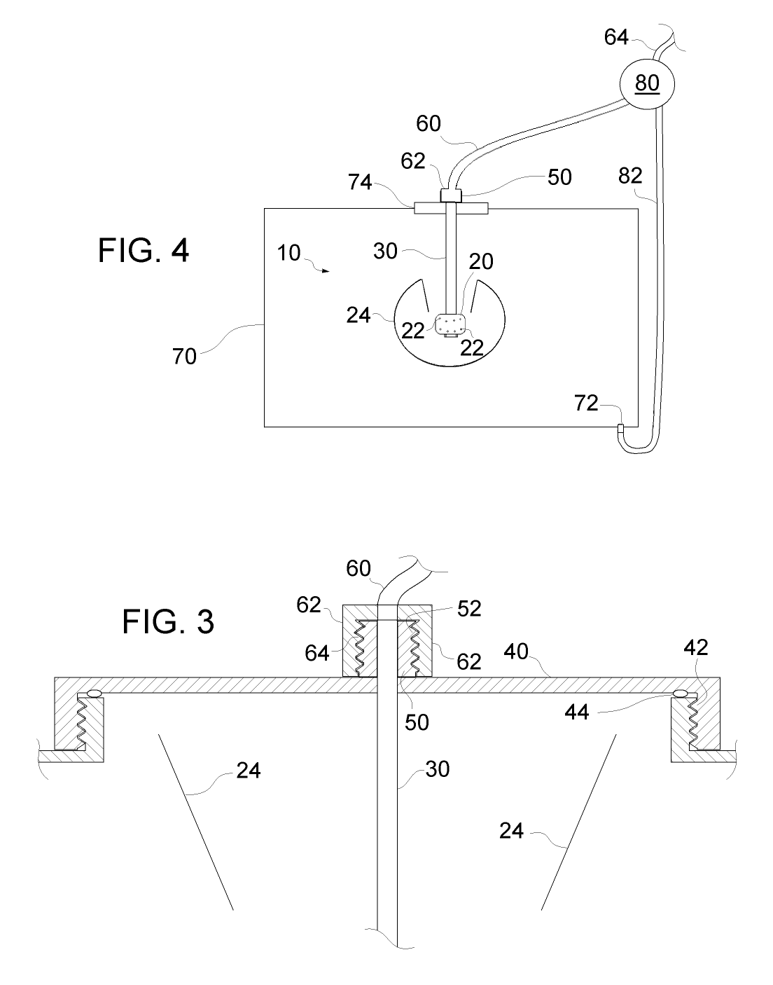

The cap 40 is shown in detail in FIG. 3. The cap 40 is, in one embodiment as shown, a molded plastic element. The cap 40 is configured to substantially seal the mini-bulk container opening 74 when attached to the container opening 74. The cap 40 includes an annular seal in the form of an o-ring 44 configured to engage the mini-bulk container 70 around the mini-bulk container opening 74 when the cap 40 is attached to the mini-bulk container opening 74. The cap 74 includes an attaching mechanism in the form of threads 42 for attaching the cap 40 to the mini-bulk container opening 74. The threads 42 can be replaced with a snap fit member engaging over a bead on the container 70. The cap 40, if formed of plastic, may be easily formed from injection molding.

The cap 40 may be easily formed from an existing cap for the opening 74 which is modified to add the tube 30 there through in a sealed manner, together with coupling 50 and spray head 20. Additional seals could be added to seal the cap 50 around the tube 30, although adhesive may be sufficient sealing between thee members.

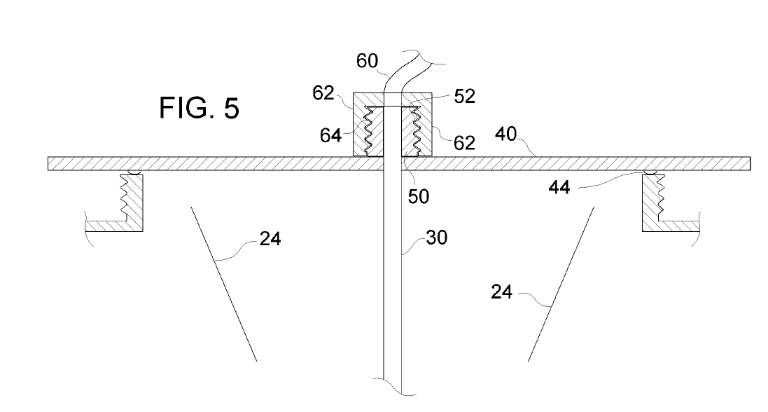

An alternative embodiment that can increase the application of the system 10 to a wider variety of containers 70 is to utilize a relatively heavy metal (e.g., steel) flat plate to form cap 40 as shown schematically in FIG. 5. In this embodiment the weight of the system 10, mainly the weight of the metal plate cap 40, will serve as the “attaching mechanism” to hold the system 10 onto the container 70 in operation. The sealing can be a metal to plastic line seal created via the weight of the system, or a flat gasket can be formed with a rubberized layer forming seal 44 on the underside of the flat metal cap 40.

The fluid coupling 50 is preferably formed as a conventional fluid coupling such as one that includes threads 52 for attaching to the source of cleaning fluid, e.g., a garden hose attachment. An alternative method of attachment would be through known quick-connect fitting, such as known as a Banjo or Cam-Lock fitting. The fluid coupling 50 is attached to a distal end of the tube 30 on the side of the cap 40 that is exterior to the container 70 when the system 10 is coupled to the container 70. The fluid coupling 50 may be secured to the top of the cap 40, such as through adhesives or the like, which can act to further seal the system 10.

The operation of the portable automated mini-bulk container rinsing system 10 according to one aspect of the invention provides that the operator will first attach the cap 40 of the mini-bulk container rinsing system 10 to an opening 74 in the mini-bulk container 70 by engaging thread 42 with the threads of the container 70 around the opening 74 to position the spray head 20 in positioning the interior of the mini-bulk container 70. The user can then attach the fluid coupling member 50 to a source of cleaning fluid (generally represented by hose 60) by threading hose coupling 60 to coupling 50 with engaging threads 62 and 52. Following this attachment, the user can turn on the source of cleaning fluid typically by turning a valve at the distal end of hose 60 which will supply cleaning fluid under pressure from the source of cleaning fluid to the rinsing system 10 whereby cleaning fluid under pressure can flow from the source, through the fluid coupling 50, through the tube 30 and through the rotary spray head 20 to rinse the entire interior surface of the mini-bulk container 70. After a set period of time (such as ½-1½ minutes) the valve is turned off to stop the automatic rinsing process.

Typically rinsate from the container 70 can be directed via outlet 72 directly into a user's sprayer tank to efficiently and economically use all pesticide and/or fertilizer in the container 70. An alternative arrangement is shown in FIG. 4 where the rinsate is re-used for rinsing of the mini-bulk container 70 by being directed via tube 82 to pump 80 to be re-introduced into the container 70. The line 64 comes from the source of cleaning fluid, such as water, and the line 60 is for cleaning fluid and rinsate. This recycling of rinsate is useful where the rinsate cannot be effectively used in the field and must be collected. It is expected that in this environment the rinsate will be re-used until it reaches a level of impurity (measured by time in use (e.g., every two weeks), or cycles of operation (e.g. number of container 70 that are rinsed), or measured by a sensor (e.g., particulate counter) where the used rinsate is no longer is effective for cleaning the mini-bulk containers 70, and then must be directed to a separate containment unit and properly disposed of.

Another embodiment of the invention includes an on-off valve at or near the coupling 50 to allow the user to control the operation at the coupling 50 after the source of cleaning fluid (e.g., water) 60 is attached (and turned “on” via existing valve). This would easily be formed with an additional on- off fluid valve. Another addition could include a pressure gauge in the line to display to the user that the system is operating at sufficient pressure to rinse the tank. The additional modification of adding a pressure gauge may not be cost effective as the system is generally designed to operate on conventional line pressures which are not controllable by the user. In other words the system will, in most cases, merely be turned “on” and operate at the conventional line pressures, which can be in a wide range of acceptable values, such that an inline pressure gauge telling the user what the specific operating pressure actually is may not be particularly useful information in most applications. However, where this is a concern this modification can be easily implemented.

The present invention provides a simple method for preparing a mini-bulk container for reuse or disposal by automatically rinsing the container 70 in a closed environment such that the operator and environment is fully protected.

There are many alternatives to the present invention that are within the scope of the broad teachings of this invention. The full scope and content of the present invention is defined by the appended claims and equivalents thereto.

What is claimed is:

1. A portable automated mini-bulk container rinsing system for rinsing mini-bulk containers in a closed environmentally friendly and economical manner, said system comprising:
A cap attachable to an opening in a mini-bulk container;
A rigid tube extending from the cap configured to extend into the interior of the mini-bulk container;
A spray head coupled to the tube at a distal end of the tube spaced from the cap configured to be in a position within the interior of the mini-bulk container when the cap is attached to the opening of the mini-bulk container;
A fluid coupling member attached to an end of the rigid tube opposite the spray head and adapted to be coupled to a source of cleaning fluid, wherein fluid under pressure can flow from the source, through the fluid coupling, the tube and through the spray head to rinse the mini-bulk container when the cap is coupled to the mini-bulk container opening.

2. The portable automated mini-bulk container rinsing system according to claim 1 wherein the spray head is a rotary spray head that is configured to rotate when dispensing fluid under pressure.

3. The portable automated mini-bulk container rinsing system according to claim 2 wherein the tube is substantially straight and the rotary spray head has a spray angle as measured in a plane generally parallel to a longitudinal axis of the tube that will extend from an end spray line intersecting the cap, about an arc associated with the interior of the mini-bulk container when the cap is attached to the opening of the mini-bulk container to a second end spray line intersecting the cap.

4. The portable automated mini-bulk container rinsing system according to claim 3 wherein the cap is configured to substantially seal the mini-bulk container opening when attached to the container opening.

5. The portable automated mini-bulk container rinsing system according to claim 4 wherein the cap includes an annular seal configured to engage the mini-bulk container around the mini-bulk container opening when the cap is attached to the mini-bulk container opening.

6. The portable automated mini-bulk container rinsing system according to claim 5 wherein the cap includes threads for attaching to the mini-bulk container opening.

7. The portable automated mini-bulk container rinsing system according to claim 6 wherein the fluid coupling includes threads for attaching to the source of cleaning fluid.

8. A method for rinsing a mini-bulk container comprising the steps of:
Providing a portable mini-bulk container rinsing system having a cap, a rigid tube extending from the cap with a spray head coupled to the tube at one distal end of the tube spaced from the cap, and a fluid coupling member attached to an opposed distal end of the rigid tube opposite the spray head;
Attaching the cap of the mini-bulk container rinsing system to an opening in the mini-bulk container, wherein tube and the spray head extend into the interior of the mini-bulk container;
Attaching the fluid coupling member to a source of cleaning fluid;
Supplying for a period of time cleaning fluid under pressure from the source of cleaning fluid to the rinsing system whereby fluid under pressure can flow from the source, through the fluid coupling, the tube and through the spray head to rinse the mini-bulk container.

9. The method for rinsing a mini-bulk container according to claim 8 wherein the cleaning fluid is water.

10. The method for rinsing a mini-bulk container according to claim 8 further including the step of rotating the spray head more than 360 degrees when dispensing fluid under pressure during rinsing of the mini-bulk container.

11. The method for rinsing a mini-bulk container according to claim 10 wherein the tube is substantially straight and the rotary spray head has a spray angle as measured in a plane generally parallel to a longitudinal axis of the tube that will extend from an end spray line intersecting the cap, about an arc associated with the interior of the mini-bulk container when the cap is attached to the opening of the mini-bulk container to a second end spray line intersecting the cap.

12. The method for rinsing a mini-bulk container according to claim 10 wherein the step of attaching the cap to the mini-bulk container opening includes substantially sealing the mini-bulk container opening.

13. The method for rinsing a mini-bulk container according to claim 12 wherein the cap includes an annular seal and further including the step of engaging the annular seal against the mini-bulk container around the mini-bulk container opening when the cap is attached to the mini-bulk container opening.

14. The method for rinsing a mini-bulk container according to claim 13 wherein the cap includes threads for attaching to the mini-bulk container opening.

15. The method for rinsing a mini-bulk container according to claim 14 wherein the fluid coupling includes threads for attaching to the source of cleaning fluid.

16. The method for rinsing a mini-bulk container according to claim 8 further including the step of reusing rinsate for rinsing of the mini-bulk container.

17. A method for preparing a mini-bulk container for reuse or disposal comprising the steps of:
Providing a portable mini-bulk container rinsing system having a threaded cap, a rigid tube extending from the cap with a rotary spray head coupled to the tube at one distal end of the tube spaced from the cap, and a threaded fluid coupling member attached to an opposed distal end of the rigid tube opposite the rotary spray head;
Sealing the mini-bulk container to provide a substantially closed system by attaching the threaded cap of the mini-bulk container rinsing system to an opening in the mini-bulk container, wherein tube and the rotary spray head extend into the interior of the mini-bulk container;
Attaching the fluid coupling member to a source of cleaning fluid;
Rinsing the interior to the mini-bulk container by supplying for a period of time cleaning fluid under pressure from the source of cleaning fluid to the rinsing system whereby fluid under pressure can flow from the source, through the fluid coupling, the tube and through the rotary spray head to rinse the mini-bulk container.

18. The method for preparing a mini-bulk container for reuse or disposal according to claim 17 wherein the tube is substantially straight and the rotary spray head has a spray angle as measured in a plane generally parallel to a longitudinal axis of the tube that will extend from an end spray line intersecting the cap, about an arc associated with the interior of the mini-bulk container when the cap is attached to the opening of the mini-bulk container to a second end spray line intersecting the cap.

19. The method preparing a mini-bulk container for reuse or disposal according to claim 18 wherein the cap includes an annular seal and further including the step of engaging the annular seal against the mini-bulk container around the mini-bulk container opening when the cap is attached to the mini-bulk container opening.

20. The method preparing a mini-bulk container for reuse or disposal according to claim 18 wherein the cleaning fluid is water and the rotary nozzle rotates more than 360 degrees during rinsing.
